(19) United States
(12) Patent Application Publication
(10) Pub. No.: US 2013/0193865 A1
(43) Pub. Date: Aug. 1, 2013

(54) METHOD AND APPARATUS FOR DRIVING A LIGHT EMITTING DIODE STROBE

(71) Applicants: Joseph Rudy Keller, Red Bank, NJ (US); Joseph Kosich, South Toms River, NJ (US); David John Salgueiro, Cranford, NJ (US); John Richard Celli, Long Branch, NJ (US)

(72) Inventors: Joseph Rudy Keller, Red Bank, NJ (US); Joseph Kosich, South Toms River, NJ (US); David John Salgueiro, Cranford, NJ (US); John Richard Celli, Long Branch, NJ (US)

(21) Appl. No.: 13/358,846

(22) Filed: Jan. 26, 2012

(51) Int. Cl. H05B 37/02

(52) U.S. Cl. 315/224

(57) ABSTRACT

In one embodiment, the present invention is a method and apparatus for driving a light emitting diode strobe. One embodiment of a circuit for driving a current controlled light source includes an energy storage stage for storing a charge level and an energy delivery stage for drawing current from the energy storage stage and applying a fixed amount, of current to the current controlled light source.

### FIELD OF THE INVENTION

The present invention generally relates to fire strobe applications, and more particularly relates to fire strobe applications employing light emitting diodes.

### BACKGROUND OF THE DISCLOSURE

Many conventional fire strobe applications employ xenon flash tube strobes. However, the current drawn by xenon flash tubes is significant, and consequently such fire strobe applications consume a great deal of power.

### SUMMARY OF THE INVENTION

In one embodiment, the present invention is a method and apparatus for driving a light emitting diode strobe. One embodiment of a circuit for driving a current controlled light source includes an energy storage stage for storing a charge level and an energy delivery stage for drawing current from the energy storage stage and applying a fixed amount of current to the current controlled light source.

### BRIEF DESCRIPTION OF THE DRAWINGS

The teachings of the present invention can be readily understood by considering the following detailed description in conjunction with the accompanying drawings, in which:

FIG. 1A is a block diagram illustrating a first embodiment of a light emitting diode strobe drive circuit, according to the present invention;

FIG. 1B is a circuit diagram illustrating one embodiment of the drive circuit of FIG. 1A in more detail;

FIG. 1C is a circuit diagram illustrating an alternate embodiment of the drive circuit of FIG. 1A in more detail;

FIG. 2 is a block diagram illustrating a second embodiment of a light emitting diode strobe drive circuit, according to the present invention;

FIG. 3 is a block diagram illustrating a third embodiment of a light emitting diode strobe drive circuit, according to the present invention;

FIG. 4 is a block diagram illustrating a fourth embodiment of a light emitting diode strobe drive circuit, according to the present invention;

FIG. 5 is a block diagram illustrating a fifth embodiment of a light emitting diode strobe drive circuit, according to the present invention;

FIG. 6 is a block diagram illustrating a sixth embodiment of a light emitting diode strobe drive circuit, according to the present invention; and

FIG. 7 is a high level block diagram of a microcontroller.

To facilitate understanding, identical reference numerals have been used, where possible, to designate identical elements that are common to the figures.

### DETAILED DESCRIPTION

In one embodiment, the present invention is a method and apparatus for driving a light emitting diode (LED) strobe. Embodiments of the invention draw less current than conventional xenon flash tube-based fire strobe applications (which are voltage controlled rather than current controlled), and therefore consume less power. In further embodiments, a multicandela feature allows consumers to stock a single model, allowing for further cost savings.

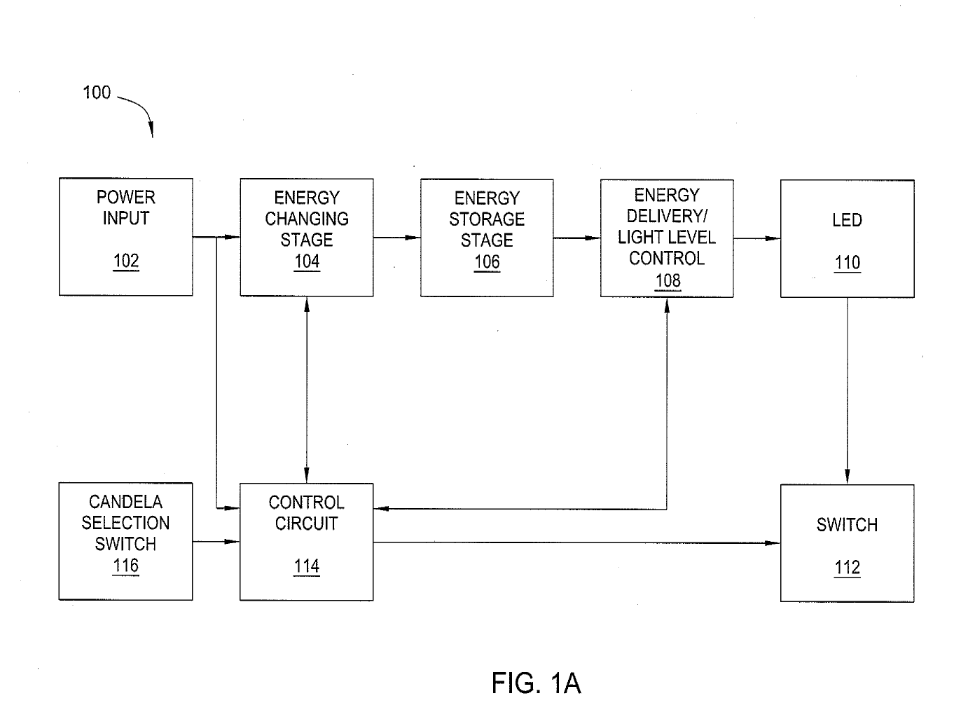

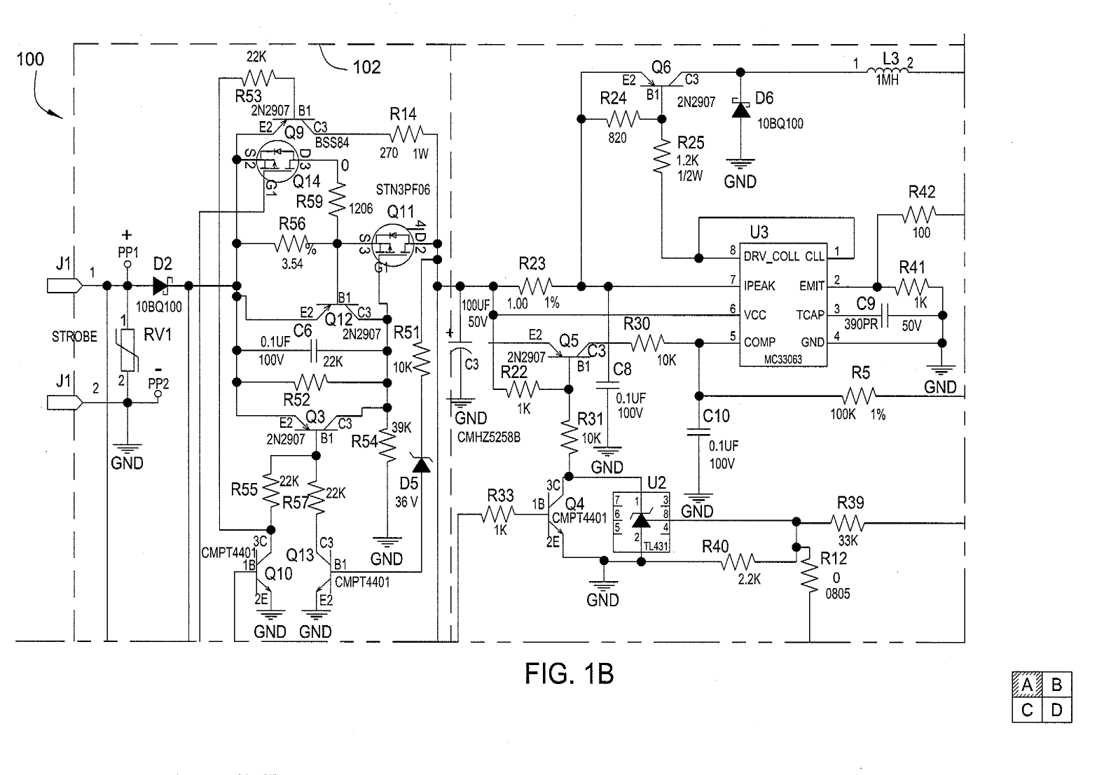

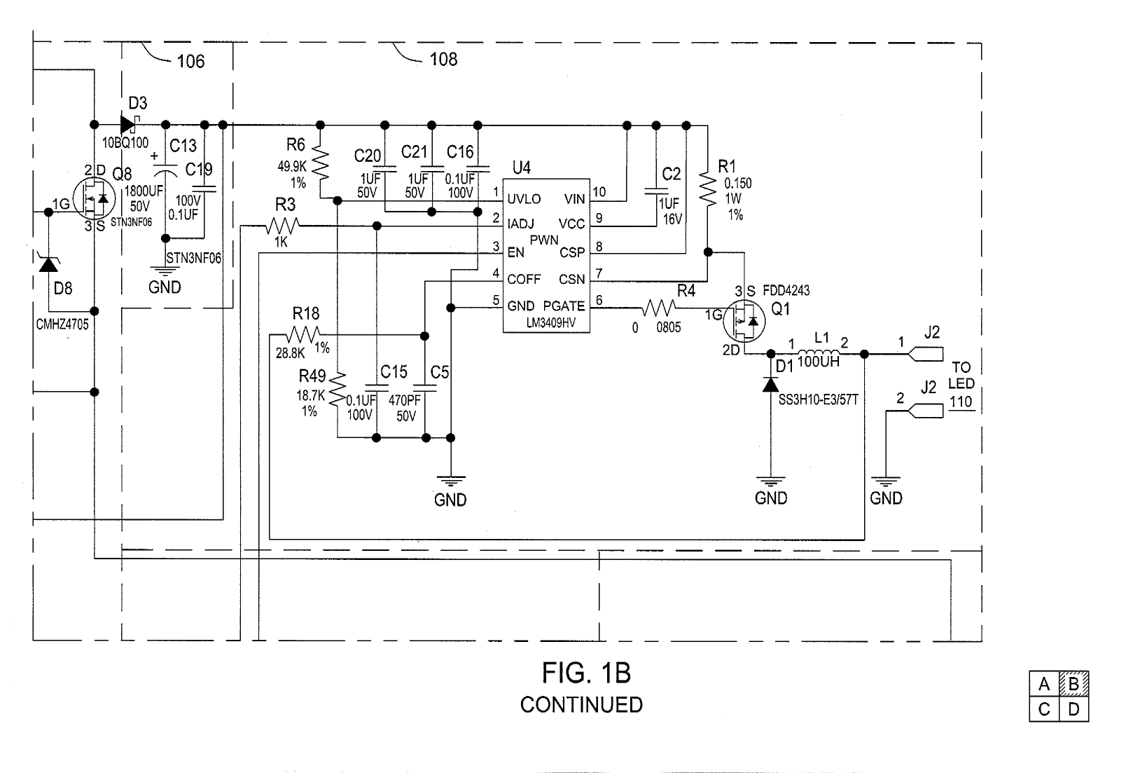

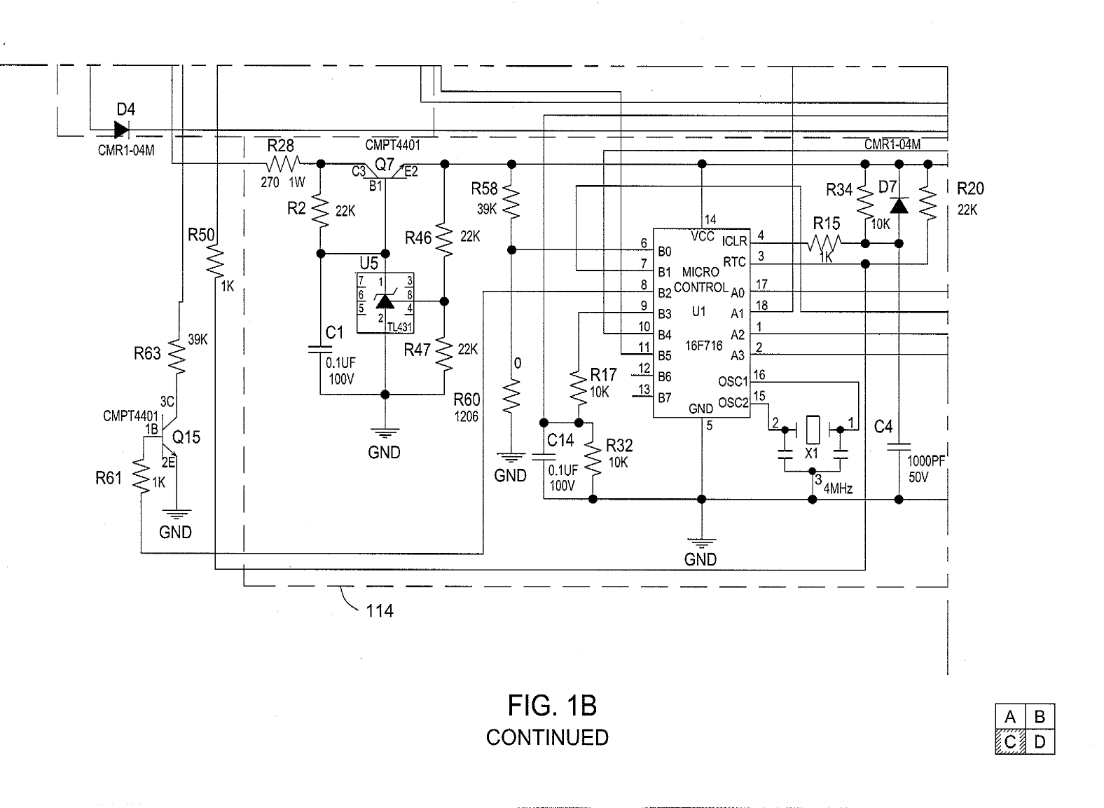

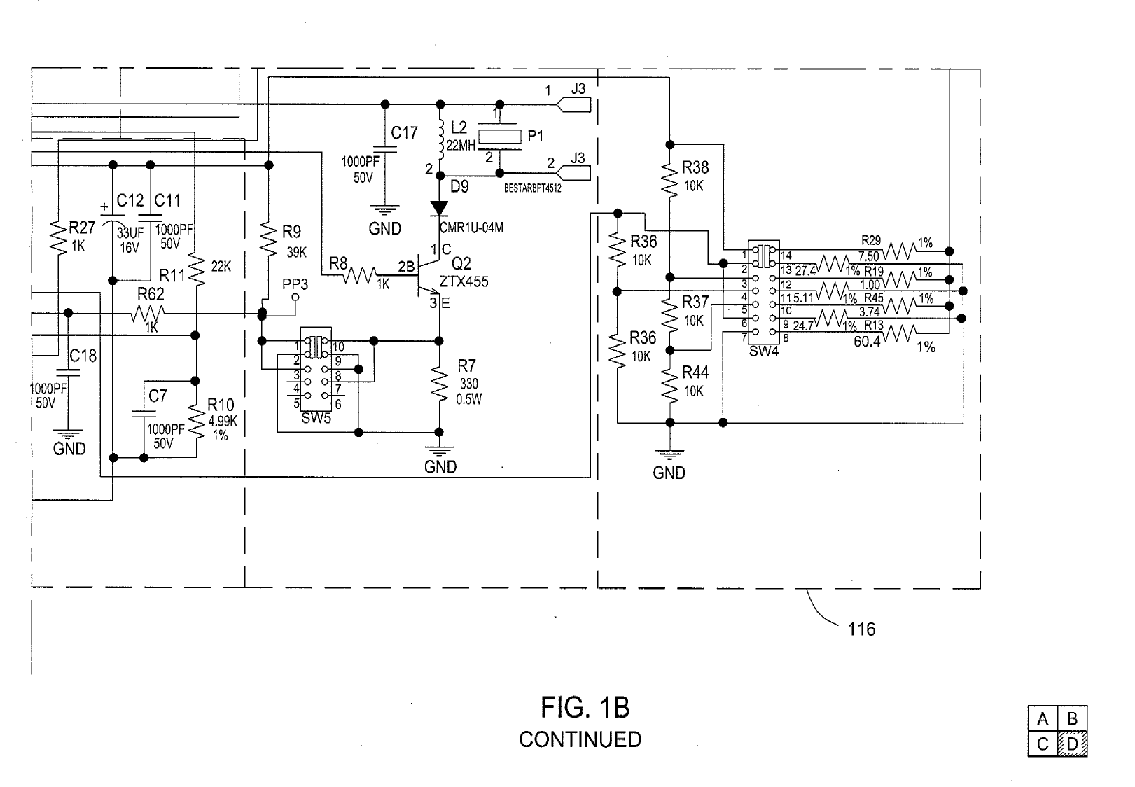

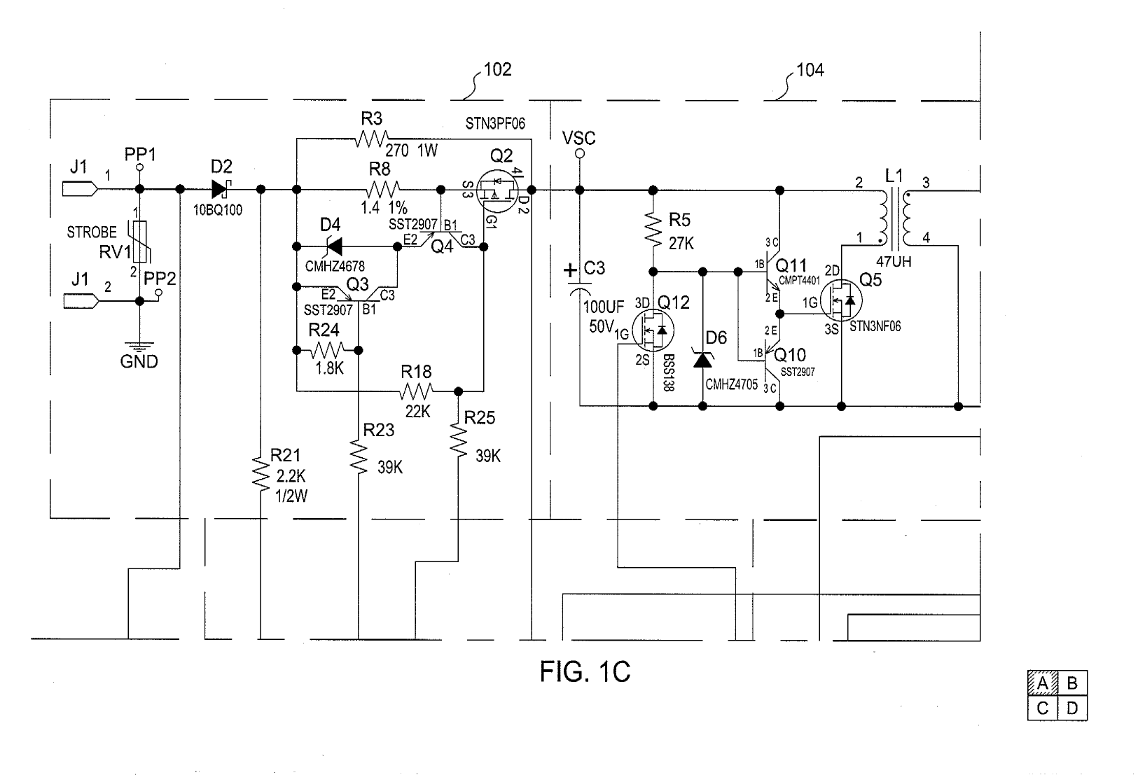

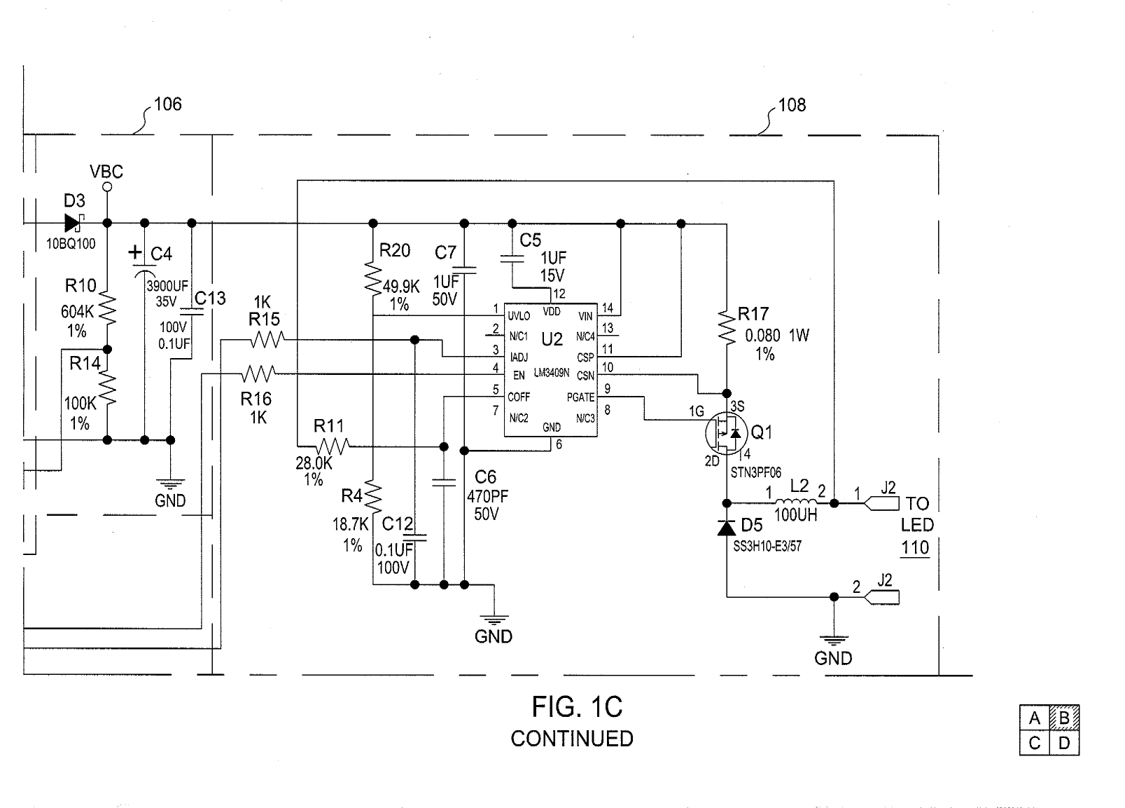

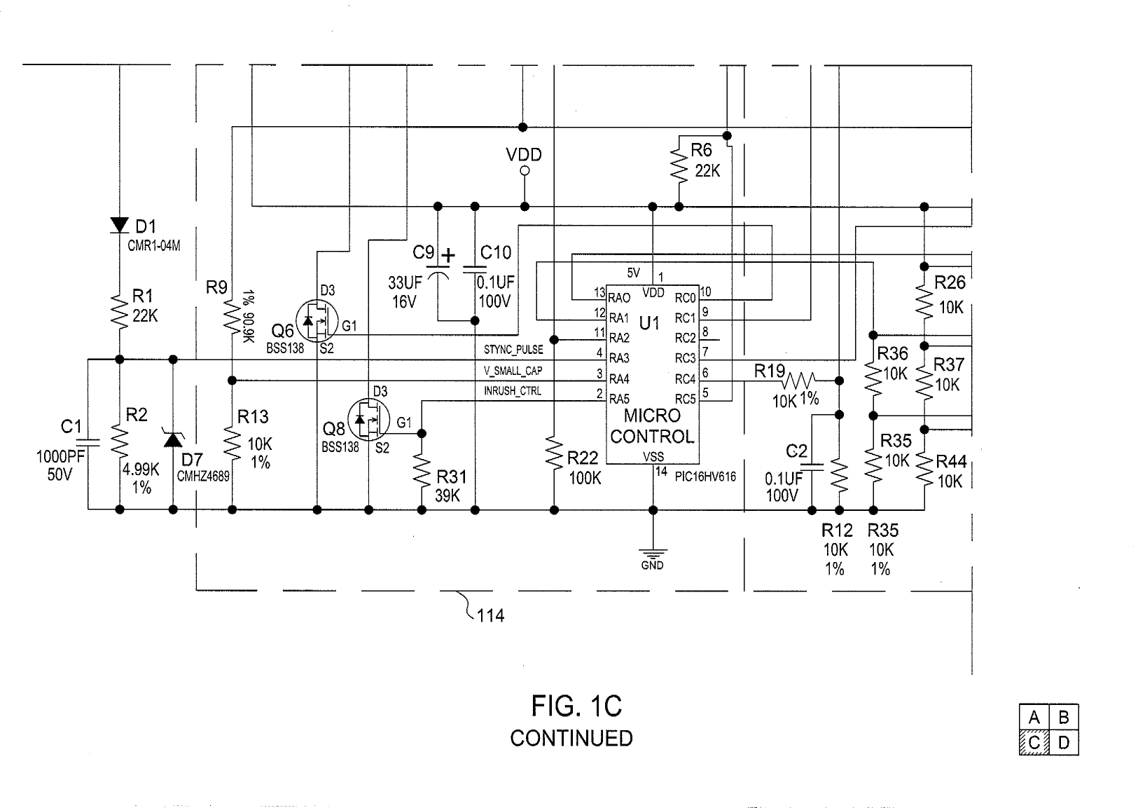

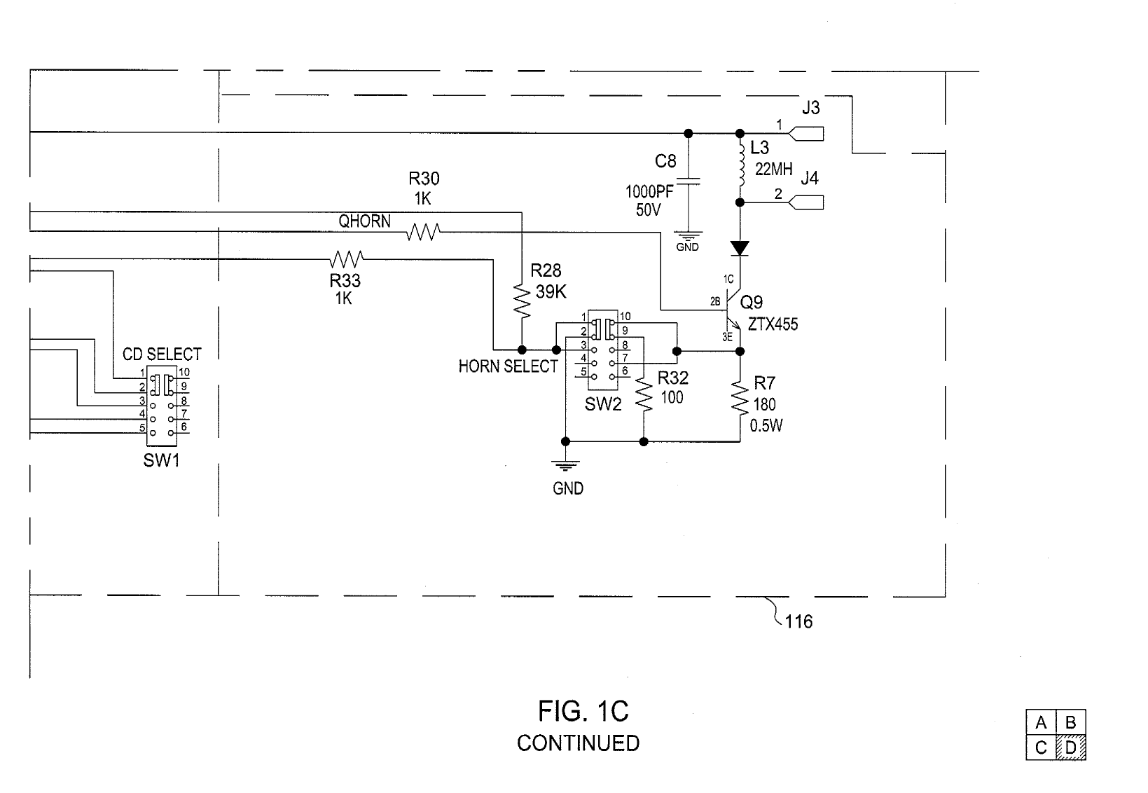

FIG. 1A is a block diagram illustrating a first embodiment of a light emitting diode strobe drive circuit 100, according to the present invention. FIG. 1A may also serve as a flow diagram that illustrates a method of operation of the drive circuit 100, when considered in conjunction with the discussion below. FIG. 1B is a circuit diagram illustrating one embodiment of the drive circuit 100 of FIG. 1A in more detail, while FIG. 1C is a circuit diagram illustrating an alternate embodiment of the drive circuit of FIG. 1A in more detail. The drive circuit 100 may be coupled, for example, to a notification appliance such as a fire alarm and/or mass notification system (not shown).

Referring simultaneously to FIGS. 1A-1C, the drive circuit 100 generally comprises a power input stage 102, an energy charging stage 104, an energy storage stage 106, an energy delivery/light level control stage 108, a current controlled light source (e.g., LED) 110, a switch 112, a control circuit 114, and a candela selection switch 116.

The power input stage 102 comprises a network of transistors and diodes that performs a variety of functions. For instance, the power input stage 102 substantially ensures that a reverse polarity is not applied to the drive circuit 100. The power input stage 102 also limits the in-rush current when the drive circuit 100 is first energized (e.g., during power on at time zero for approximately sixteen milliseconds) and enforces a peak current limit at certain points of operation of the drive circuit 100. In-rush current and peak current are typically limited by Underwriters Laboratories (UL) standards. In further embodiments, the power input stage 102 also includes a transient protection device.

The power input stage 102 is directly coupled to the energy charging stage 104. The energy charging stage 104 takes power from an input direct current (DC) rail (e.g., in the range of sixteen to thirty-three Volts DC and full wave rectified) and charges the energy storage stage 106 to a specified voltage (which may be selected by the control circuit 114, which is also directly coupled to the energy charging stage 104). Thus, the energy charging stage 104 may be thought of in generic terms as a pulse-width modulation (PWM) controller that performs DC-to-DC conversions.

The energy charging stage 104 is directly coupled to the energy storage stage 106. The energy storage stage 106 comprises a large capacitor that is charged by the energy charging stage 104, as described above. The energy stored by the energy storage stage 106 should be at least enough to support one pulse or flash of the current controlled light source 110, as discussed in greater detail below.

The energy storage stage 106 is directly coupled to the energy delivery/light level control stage 108. The energy delivery/light level control stage 108 draws power from the energy storage stage 106 and applies a specific amount of DC current to the current controlled light source 110 (which may reside on a different printed circuit board than the rest of the drive circuit 100) for a specific amount of time. Thus, the energy delivery/light level control stage 108 may also be thought of as a PWM controller that performs DC-to-DC conversions. That is, pulse-width modulation is used to convert energy drawn from the energy storage stage 106 into a fixed current (which corresponds to a fixed light level) for the current controlled light source 110. The fixed current should be at least enough to support one pulse or flash of the current controlled light source 110. The luminous intensity (e.g., candelas) relative to the drive current will vary according to the specific current controlled light source 110 that is deployed.

In one embodiment, the fixed current is selected by the control circuit 114, which is also directly coupled to the energy delivery/light level control stage 108. In an alternative embodiment, the control circuit 114 (which may include a microcontroller) may direct perform the PWM operations (thus, in this embodiment, the energy delivery/light level control stage 108 and the control circuit 114 may comprise a single integrated circuit rather than two separate integrated circuits). As the energy delivery/light level control stage 108 draws energy from the energy storage stage 106, the voltage of the energy storage stage 106 will slowly drop.

The control circuit 114, discussed above, is also directly coupled to the candela selection switch 116. The candela selection switch 116 comprises a network of resistors and is controllable by a user. In particular, the candela selection switch 116 conveys to the control circuit 114, under the direction of the user, what luminous intensity is selected for the current controlled light source 110. In one embodiment, the candela selection switch 116 provides for selection of one of a plurality of potential luminous intensities (e.g., in fifteen candela increments from fifteen candelas up to seventy-five candelas). Those skilled in the art will recognize that the candela rating of the current controlled light source 110 is effectively determined by the duration of the pulse and the magnitude of the current.

As discussed above, the current controlled light source 110 may be an LED. In one embodiment, the current controlled light source 110 is a particular type of LED known in the art as a “183A” LED (also known as an “NS6W183A” LED). A 183A LED actually comprises six LEDs in a single package. In one embodiment, a 183A LED can produce luminous intensity in fifteen candela increments, from fifteen candelas up to seventy-five candela.

In another embodiment, the current controlled light source 110 comprises multiple LEDs (e.g., as opposed to a single LED) in series or in parallel, which allows for even greater luminous intensity. For instance, a multi-LED embodiment may be capable of producing luminous intensity in the range of 110 candelas and above.

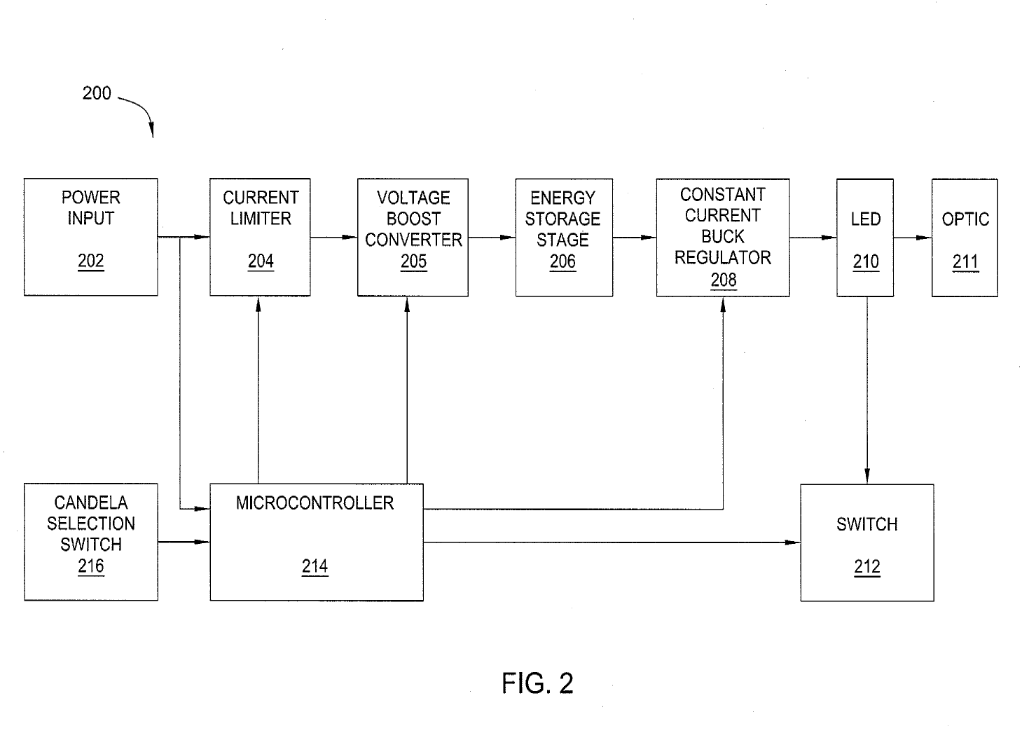

Those skilled in the art will appreciate that the configuration of the drive circuit 100 is not limited to what is illustrated in FIGS. 1A-1C. For example, the functionalities of two or more components of the drive circuit 100 may be integrated into a single component (e.g., as mentioned above with respect to the energy delivery/light level control stage 108 and the control circuit 114). Still further embodiments of a drive circuit are illustrated in FIGS. 2-6. Furthermore, the drive circuit 100 may comprise components in addition to those illustrated, where the additional components perform other functionalities. For example, a sounder circuit may also be incorporated in the drive circuit 100, although it is not required to drive the current controlled light source 110. The sounder circuit controls the audible portion of the notification appliance to which the drive circuit 100 is coupled.

The drive circuit 100 provides for greatly improved system reliability, predictability of operation, and light level control. These advantages are achieved in part through the inclusion of the energy delivery/light level control stage 108.

FIG. 2 is a block diagram illustrating a second embodiment of a light emitting diode strobe drive circuit 200, according to the present invention. FIG. 2 may also serve as a flow diagram that illustrates a method of operation of the drive circuit 200, when considered in conjunction with the discussion below.

The drive circuit 200 is substantially similar to the drive circuit 100 illustrated in FIGS. 1A-1C and generally comprises a power input stage 202, a current limiter 204, a voltage boost converter 205, an energy storage stage 206, a constant current buck regulator 208, a current controlled light source (e.g., LED) 210, an optic 211, a switch 212, a microcontroller 214, and a candela selection switch 216.

Thus, the operation of the drive circuit 200 is substantially similar to the operation of the drive circuit 100. However, the drive circuit 200 provides specific exemplary implementations of the energy charging stage 104 and the energy delivery/light level control stage 108 described above. In addition, the power input stage 202 and the current limiter 204 comprise separate components (as opposed to both being incorporated in a power input stage 102 as illustrated in FIGS. 1A-1C). The current controlled light source 210 is also coupled to an optic 211.

In particular, the drive circuit 200 may be thought of as a boost-buck implementation of the drive circuit 100. Thus, the energy charging stage is implemented in the drive circuit 200 using the voltage boost converter 205. The voltage boost converter 205 is a specific type of PWM DC-to-DC converter. Current to the current controlled light source 210 is controlled by the constant current buck regulator 208 (also a DC-to-DC converter).

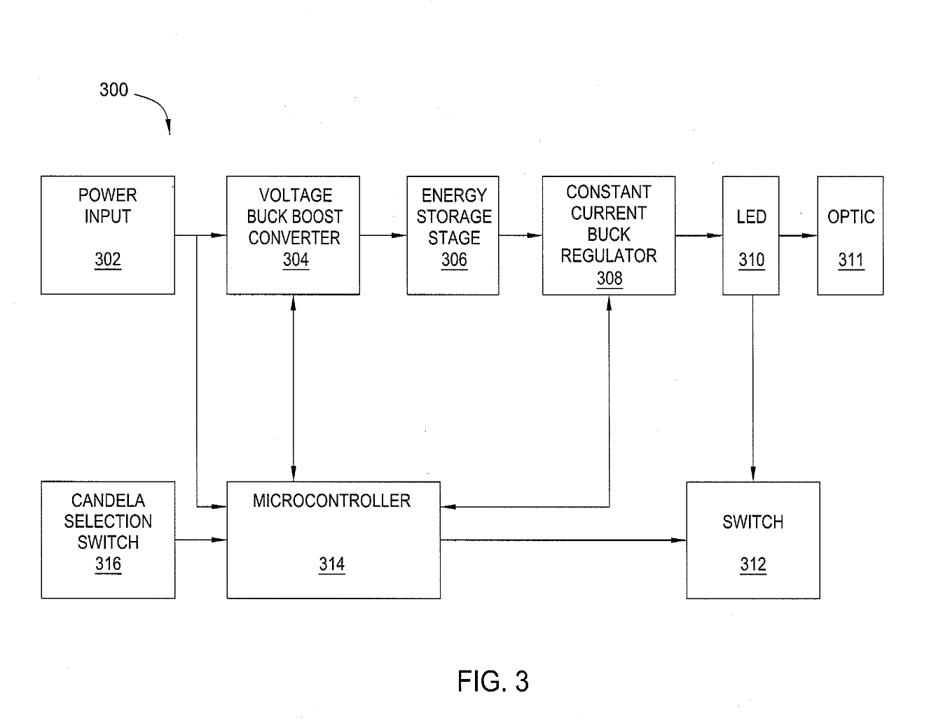

FIG. 3 is a block diagram illustrating a third embodiment of a light emitting diode strobe drive circuit 300, according to the present invention. FIG. 3 may also serve as a flow diagram that illustrates a method of operation of the drive circuit 300, when considered in conjunction with the discussion below.

The drive circuit 300 is substantially similar to the drive circuit 100 illustrated in FIGS. 1A-1C and generally comprises a power input stage 302, a voltage buck boost converter 304, an energy storage stage 306, a constant current buck regulator 308, a current controlled light source (e.g., LED) 310, an optic 311, a switch 312, a microcontroller 314, and a candela selection switch 316.

Thus, the operation of the drive circuit 300 is substantially similar to the operation of the drive circuit 100. However, the drive circuit 300 provides specific exemplary implementations of the energy charging stage 104 and the energy delivery/light level control stage 108 described above. The current controlled light source 310 is also coupled to an optic 311.

In particular, the drive circuit 300 may be thought of as a buck-boost-buck implementation of the drive circuit 100. Thus, the energy charging stage is implemented in the drive circuit 300 using the voltage buck boost converter 304. The voltage buck boost converter 304 is a specific type of PWM DC-to-DC converter. Those skilled in the art will recognize that “buck” indicates a transition from a higher voltage to a lower voltage, while a “boost” indicates a transition from a lower voltage to a higher voltage. Thus, a “buck boost” is a combination of a “buck” and a “boost.” Current to the current controlled light source 210 is controlled by the constant current buck regulator 208.

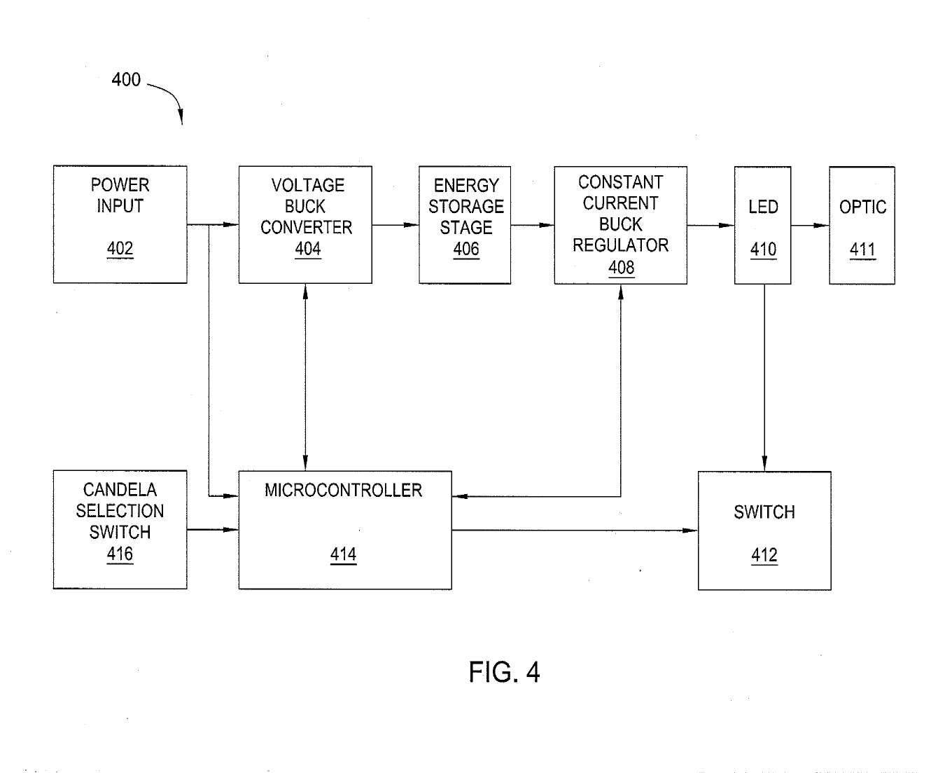

FIG. 4 is a block diagram illustrating a fourth embodiment of a light emitting diode strobe drive circuit 400, according to the present invention. FIG. 4 may also serve as a flow diagram that illustrates a method of operation of the drive circuit 400, when considered in conjunction with the discussion below.

The drive circuit 400 is substantially similar to the drive circuit 100 illustrated in FIGS. 1A-1C and generally comprises a power input stage 402, a voltage buck converter 404, an energy storage stage 406, a constant current buck regulator 408, a current controlled light source (e.g., LED) 410, an optic 411, a switch 412, a microcontroller 414, and a candela selection switch 416.

Thus, the operation of the drive circuit 400 is substantially similar to the operation of the drive circuit 100. However, the drive circuit 400 provides specific exemplary implementations of the energy charging stage 104 and the energy delivery/light level control stage 108 described above. The current controlled light source 410 is also coupled to an optic 411.

In particular, the drive circuit 400 may be thought of as a buck-buck implementation of the drive circuit 100. Thus, the energy charging stage is implemented in the drive circuit 400 using the voltage buck converter 404. The voltage buck converter 404 is a specific type of PWM DC-to-DC converter. Current to the current controlled light source 410 is controlled by the constant current buck regulator 408.

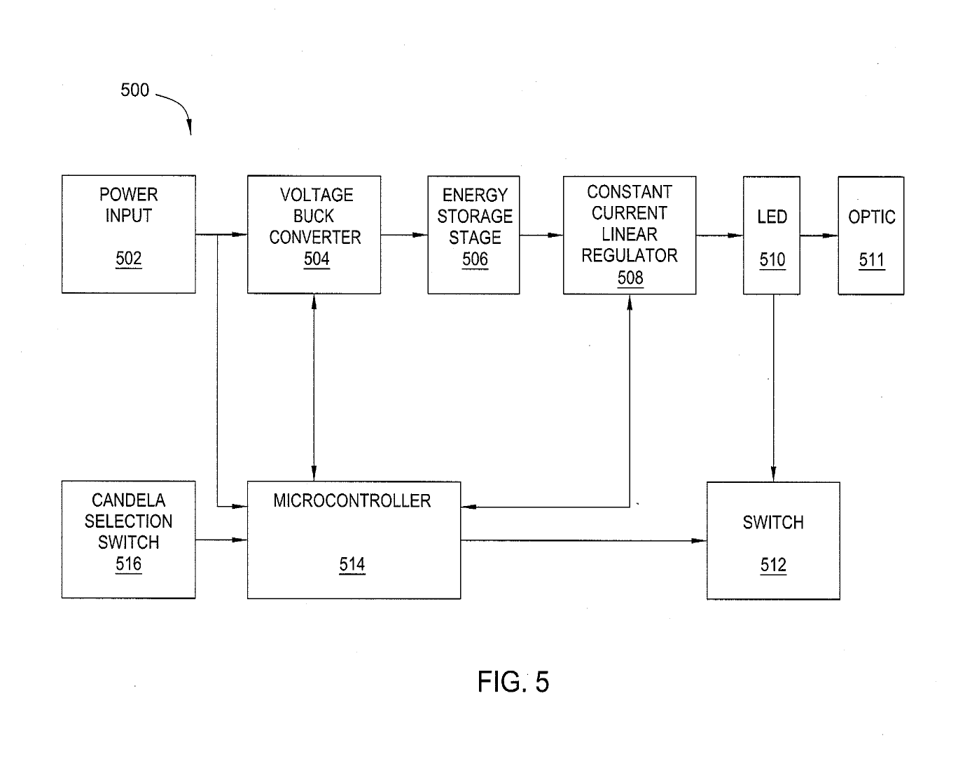

FIG. 5 is a block diagram illustrating a fifth embodiment of a light emitting diode strobe drive circuit 500, according to the present invention. FIG. 5 may also serve as a flow diagram that illustrates a method of operation of the drive circuit 500, when considered in conjunction with the discussion below.

The drive circuit 500 is substantially similar to the drive circuit 100 illustrated in FIGS. 1A-1C and generally comprises a power input stage 502, a voltage buck converter 504, an energy storage stage 506, a constant current linear regulator 508, a current controlled light source (e.g., LED) 510, an optic 511, a switch 512, a microcontroller 514, and a candela selection switch 516.

Thus, the operation of the drive circuit 500 is substantially similar to the operation of the drive circuit 100. However, the drive circuit 500 provides specific exemplary implementations of the energy charging stage 104 and the energy delivery/light level control stage 108 described above. The current controlled light source 510 is also coupled to an optic 511.

In particular, the drive circuit 500 may be thought of as a buck-linear implementation of the drive circuit 100. Thus, the energy charging stage is implemented in the drive circuit 500 using the voltage buck converter 504. The voltage buck converter 504 is a specific type of PWM DC-to-DC converter. Current to the current controlled light source 510 is controlled by the constant current linear regulator 508 (which is not a switching converter, but is more of a shunt regulator).

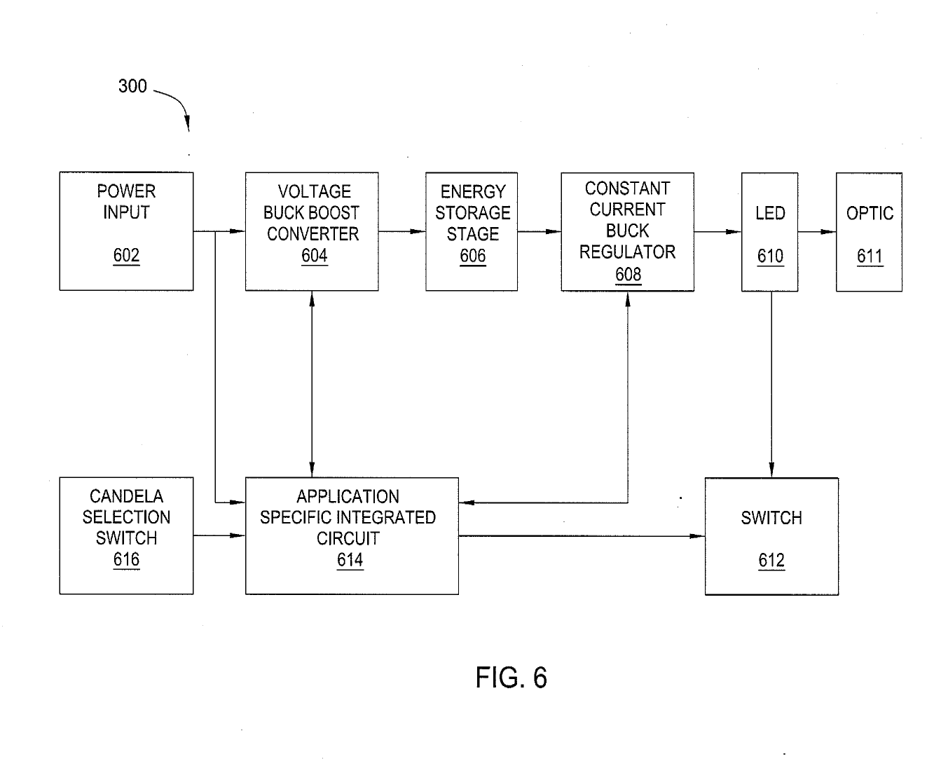

FIG. 6 is a block diagram illustrating a sixth embodiment of a light emitting diode strobe drive circuit 600, according to the present invention. FIG. 6 may also serve as a flow diagram that illustrates a method of operation of the drive circuit 600, when considered in conjunction with the discussion below.

The drive circuit 600 is substantially similar to the drive circuit 100 illustrated in FIGS. 1A-1C and generally comprises a power input stage 602, a voltage buck boost converter 604, an energy storage stage 606, a constant current buck regulator 608, a current controlled light source (e.g., LED) 610, an optic 611, a switch 612, an application specific integrated circuit (ASIC) 614, and a candela selection switch 616.

Thus, the operation of the drive circuit 600 is substantially similar to the operation of the drive circuit 100. However, the drive circuit 600 provides specific exemplary implementations of the energy charging stage 104 and the energy delivery/light level control stage 108 described above. The current controlled light source 610 is also coupled to an optic 611. In addition, the ASIC 614 replaces the microcontroller used in previous embodiments.

In particular, the drive circuit 600 may be thought of as a buck-boost-buck ASIC-driven implementation of the drive circuit 100. Thus, the energy charging stage is implemented in the drive circuit 600 using the voltage buck boost converter 604. The voltage buck boost converter 604 is a specific type of PWM DC-to-DC converter, as discussed above. Current to the current controlled light source 610 is controlled by the constant current buck regulator 608. In addition, the drive circuit 600 is driven by the ASIC 614, as discussed above.

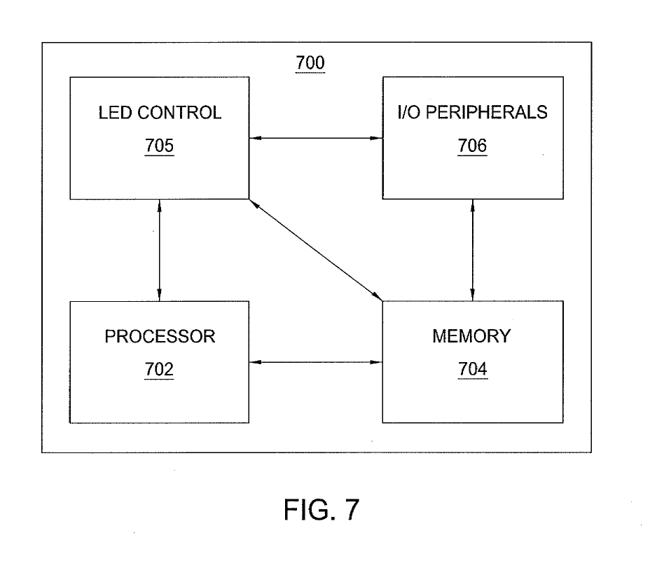

FIG. 7 is a high level block diagram of a microcontroller 700. The microcontroller 700 may be deployed as the microcontroller in any of the drive circuit embodiments discussed above. In one embodiment, a microcontroller 700 comprises a processor 702, a memory 704, an LED control module 705 and various input/output (I/O) peripherals 706 such as I/O ports, universal asynchronous receiver/transmitters (UARTs), timers, counters, and the like. In one embodiment, at least one I/O peripheral is coupled to a storage device (e.g., a disk drive, an optical disk drive, a floppy disk drive). It should be understood that the LED control module 705 can be implemented as a physical device or subsystem that is coupled to a processor through a communication channel.

Alternatively, the LED control module 705 can be represented by one or more software applications (or even a combination of software and hardware, e.g., using ASICs), where the software is loaded from a storage medium (e.g., via I/O peripherals 706) and operated by the processor 702 in the memory 704 of the microcontroller 700. Additionally, the software may run in a distributed or partitioned fashion on two or more microcontrollers similar to the microcontroller 700. Thus, in one embodiment, the LED control module 705 for driving an LED strobe described herein with reference to the preceding figures can be stored on a computer readable storage device (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step. Moreover, although steps of the methods described above may be illustrated in a certain sequence, those skilled in the art will appreciate that the steps of the methods described need not necessarily occur in the order illustrated. Thus, the accompanying Figures do not illustrate a mandatory sequential order.

Although various embodiments which incorporate the teachings of the present invention have been shown and described in detail herein, those skilled in the art can readily devise many other varied embodiments that still incorporate these teachings.

What is claimed is:

1. A circuit for driving a current controlled light source, comprising:
an energy storage stage for storing a charge level; and
an energy delivery stage for drawing current from the energy storage stage and applying a fixed amount of current to the current controlled light source.

2. The circuit of claim 1, wherein the energy delivery stage comprises a pulse-width modulation controller that performs a direct current-to-direct current conversion.

3. The circuit of claim 1, wherein the energy delivery stage comprises a constant current buck regulator.

4. The circuit of claim 1, wherein the energy delivery stage comprises a constant current linear regulator.

5. The circuit of claim 1, further comprising:
a controller for specifying the fixed amount of the current.

6. The circuit of claim 5, wherein the controller is a microcontroller.

7. The circuit of claim 5, wherein the controller is an application specific integrated circuit.

8. The circuit of claim 5, wherein the energy delivery stage is integrated with the controller.

9. The circuit of claim 1, wherein the charge level stored by the energy storage stage is of a specified voltage.

10. The circuit of claim 1, further comprising:
an energy charging stage for converting an input voltage and current to the charge level with a specified voltage.

11. The circuit of claim 10, wherein the energy charging stage comprises a pulse-width modulation controller that performs a direct current-to-direct current conversion.

12. The circuit of claim 10, wherein the energy charging stage comprises a voltage boost converter.

13. The circuit of claim 10, wherein the energy charging stage comprises a voltage buck boost converter.

14. The circuit of claim 10, wherein the energy charging stage comprises a voltage buck converter.

15. The circuit of claim 1, wherein the current controlled light source comprises at least one light emitting diode.

16. The circuit of claim 1, wherein the current controlled light source has a plurality of settings for providing luminous intensity in a range of candela ratings.

17. The circuit of claim 1, further comprising:
a candela selection switch controllable by a user to select a luminous intensity of the current controlled light source.

18. The circuit of claim 1, wherein the circuit is coupled to a notification appliance.

19. A method for driving a current controlled light source, the method comprising:
storing a charge level; and
applying a fixed amount of current to the current controlled light source.

20. A computer readable storage medium containing an executable program for driving a current controlled light source, where the program performs steps of:
storing a charge level; and
applying a fixed amount of current to the current controlled light source.
